(19) United States
(12) Patent Application Publication
(10) Pub. No.: US 2008/0019375 A1
(43) Pub. Date: Jan. 24, 2008

(54) Method and Device for Optimizing the Utilization of the Capacity of a Communication Network

(76) Inventors: Joachim Charzinski, Munchen (DE); Uwe Walter, Weingarten (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/660,813

(22) PCT Filed: Aug. 17, 2005
(86) PCT No.: PCT/EP05/54037

§ 371 Date: Feb. 22, 2007

(30) Foreign Application Priority Data
Aug. 24, 2004 (DE) 10 2004 041 013.5

(51) Int. Cl. H04L 12/24; H04L 12/56

(52) U.S. Cl. 370/395.21

(57) ABSTRACT

In one aspect, the probability of non-admittance of traffic is determined and weighed according to the admittance threshold value. Also, the probability of non-compliance of at least one service quality characteristic is determined and weighed during the transfer of traffic according to the admittance threshold value. The optimum admittance threshold value for traffic is determined according to the weighted probabilities.

### CROSS REFERENCE TO RELATED APPLICATIONS

This application is the US National Stage of International Application No. PCT/EP2005/054037, filed Aug. 17, 2005 and claims the benefit thereof. The International Application claims the benefits of German application No. 102004041013.5 DE filed Aug. 24, 2004, both of the applications are incorporated by reference herein in their entirety.

### FIELD OF INVENTION

The invention relates to a method for determining an admission threshold which is optimized in respect of the transmission of traffic in a communication network with access restriction and to a device comprising means for performing a method of said kind.

### BACKGROUND OF INVENTION

One of the most important advances at the present time in the networks field is the further development of data networks for the purpose of transmitting real-time traffic, e.g. voice, video or audio information. Toward that end, in contrast to traditional data networks which generally only provide transmission without quality-of-service guarantees (a term also used in this context in relation to the transmission quality is “best effort”), data networks further developed for the purpose of transmitting real-time traffic must be able to guarantee compliance with quality-of-service features. Current data networks are based to a large extent on the forwarding or, as the case may be, switching of packets, such as, for example, the internet using the IP (Internet Protocol) protocol for transporting data packets. Data networks of this kind are also referred to as packet networks.

Various approaches exist for monitoring the transmission quality of traffic transported over packet networks. A common aspect of these approaches is that the data rate of the traffic must be adjusted according to the available bandwidth or, as the case may be, must be reduced. One way of doing this is to provide, in the case of transmission over a network, an admission control means which leads to an access restriction if traffic volumes become too high. Data streams to be transmitted must then sign on or, as the case may be, register at the network boundary. If sufficient bandwidth is available within the network, a reservation is then made for the traffic requiring to be transmitted so that no degradation of quality due to bottlenecks can arise. This approach has the disadvantage that when the limit or limits used for the admissibility check is or are reached, transmission requests from traffic streams will be rejected.

Experience shows that the bandwidths reserved for transmission of traffic are higher than the capacity actually used by the traffic. When bandwidth or, as the case may be, capacity is reserved, it is usual to specify a peak value or an upper limit which is not reached or is reached only temporarily by the traffic conveyed. When there are a plurality of reservations this means that the loading of the network with traffic is generally lower than the aggregated reservations. In order to achieve a better utilization of the capacity of the network it is therefore frequently the practice to admit more traffic for transmission over the network than would be possible with the conservative approach of not allowing the totality of reservations to exceed the available bandwidth. In this connection it is also common to talk of an overbooking of the network, since the nominal values of the traffic to be transmitted or, as the case may be, the reservation requests of said traffic exceed the available bandwidth. What is referred to as the “overbooking factor” is used as a measure for the degree to which the bandwidth is exceeded, said overbooking factor corresponding to the ratio of the aggregated bandwidth or capacity reservation to the total available capacity. With the conservative approach this factor would be a maximum of one. In order to enable a network to be overbooked in a selective manner, certain heuristic approaches exist, such as, for example, basing the admission on regular measurements (this is referred to as Measurement Based Admission Control (MBAC)) or using empirical values for the ratio of registered traffic to traffic actually to be conveyed as a reference (usually referred to as Experience Based Admission Control (EBAC)).

### SUMMARY OF INVENTION

An object of the invention is to specify a systematic approach for optimizing the utilization of the capacity of a communication network.

This object is achieved by a method and a device.

It is proposed according to the invention to consider the optimizing of the utilization of network capacity as an optimization problem. The following two important aspects must be taken into account for the utilization of the network's capacity and the specification of the traffic admitted conditional upon an access restriction:

As much traffic as possible should be transmitted over the network. To put it another way, the probability that traffic will not be admitted (also referred to hereinafter as blocking probability) should be reduced to an absolute minimum.

On the other hand, as little traffic or, as the case may be, as few packets as possible should be affected by violation of the quality-of-service features to be complied with (e.g. delay times, loss rate etc.).

The two objectives are conflicting since on the one hand the transmission quality suffers if too much traffic is admitted, and on the other hand a very conservative access restriction leads to a high blocking probability.

The optimization according to the invention consists in determining and weighting the blocking probability as a function of the admission threshold used for the admission of traffic and equally in determining and also weighting the probability for violation of at least one quality-of-service feature likewise as a function of the admission threshold. The optimum admission threshold or, as the case may be, optimum limit for the admitted traffic is then determined in accordance with these weighted variables. This determination can be performed for example in the form of a search for the minimum of a curve given by addition of the two weighted probabilities.

It is immediately comprehensible that the method works analogously if corresponding average values for the blocked proportion of traffic or, as the case may be, the proportion of traffic with violation of a quality-of-service feature are used instead of the probabilities.

The method according to the invention provides a systematic procedure for optimizing the utilization of network capacity. This can take place for example according to business management criteria, so that an optimized operating point of the network is established as a result of the optimized admission threshold.

The method according to the invention can be extended in an obvious way to different classes of traffic and/or different types of quality-of-service violation. For this purpose the traffic class or, as the case may be, quality-of-service violation is in each case assigned a separate weighting and the sum of weighted probabilities is determined as a function of the admission threshold(s). In this way the total costs of a traffic loading can be optimized taking into account different traffic classes and/or different types of quality-of-service violation.

It is frequently the case that nominal limits for the total utilization of capacity in a network are determined for the access restriction. These limits then usually correspond to the available bandwidth. A conservative approach is to use this limit as a reference point during the reservation, i.e. to make maximum reservations up to this limit. In this case the probability for the violation of quality-of-service features would be practically equal to zero. Based on a network of this kind, the utilization of capacity is often improved by operating with overbooking or, as the case may be, introducing an overbooking factor. In this case the method according to the invention can be used to determine the optimum overbooking factor or, as the case may be, optimum overbooking.

As a result of the weighting the method according to the invention possesses a high degree of flexibility for adaptation to different network conditions or, as the case may be, network operator preferences. Weighting can be implemented using a weighting value or—more flexibly—using a weighting function. An inconsequential example of weighting is to set the weights equally in each case, i.e. to rate non-admission of traffic and violation of quality-of-service features as practically equal. The weighting can however also be used to differentiate efficiently between different situations. For example, different types of quality-of-service violations can be weighted differently. The weighting can also be used to specify a limit value for non-compliance with a quality-of-service feature. For example, violation of a quality-of-service feature (e.g. discarding of packets) shall under no circumstances exceed a probability of 2%. This condition can then be taken into account in the optimization by means of the weighting function by the weighting function for values of the admission threshold being set very high or =∞ with a probability for the quality-of-service feature violation of >2%. In this case it makes sense to work with discontinuous weighting functions.

The weighting allows in still general form boundary conditions to be introduced during the optimization for non-compliance with a quality-of-service feature or also (of less relevance for practical situations) for the blocking probability. In this case e.g. statistical functions such as the quantile can be used. For example, the probability that 5% of the traffic or, as the case may be, the packets on an average will experience a quality-of-service violation shall be < or =1%. Then, what is referred to as the 1% quantile, i.e. the value in the event space to which a value of 1% of the distribution function is assigned, is calculated. In the case given, the maximum admission threshold or, as the case may be, overbooking is calculated for which the probability that an average of 5% of the packets will violate the quality-of-service is < or =1%. For this purpose the probability distribution as a function of the admission threshold, which can be obtained, for example, from measured values or by way of an approximation, is required. The maximum admission threshold or, as the case may be, overbooking determined therefrom forms the limit, so the weight function is set very high or =∞, as a result of which a smaller value is enforced during the optimization. By means of this approach relatively complex specifications can be incorporated into the optimization. These specifications can be given for example by general economic conditions, for example by contractual sanctions if certain general values or general conditions are not complied with.

The method can also be used for automatic setting of the optimum traffic loading of the network whereby the optimum admission threshold is determined at regular intervals and the access restriction of the communication network is automatically adjusted accordingly.

According to a development the method is applied to problem scenarios of the communication network. In this case an optimum admission threshold can be determined for problem scenarios, i.e. network topologies in which one or more failures have been taken into account. These results can then be used for the provisioning of redundant capacity for preempting failures. In this case, for example, the limits for the access restriction are specified in such a way that in the event of a problem scenario operation of the network is possible at the optimum operating point determined for this scenario or, as the case may be, at the optimum admission threshold. During this determination boundary conditions can also be introduced by means of the weighting, so that it is possible to set which maximum degradation the traffic in the network will experience in the event of a problem situation. In this way limits which take into account problem situations and hence redundancy can be specified less conservatively than conventional limits.

The subject matter of the invention also includes a device comprising means for performing a method according to the invention. A device of this kind can be embodied for example by means of a server for controlling the access restriction of the communication network, by means of a network management system or by means of a service control system. In the case of a server for controlling the access restriction or, as the case may be, what is referred to as a network control server this would provide an implementation on an independent platform which can communicate with control entities for admission control, routers and the network management. Since every network has a network management system, it is also expedient to localize the functionality for performing a method according to the invention there. Another possibility is a service controller which normally handles service-specific functions such as, for example, locating a called telephone subscriber.

### BRIEF DESCRIPTION OF THE DRAWINGS

The invention is explained in more detail below within the framework of an exemplary embodiment and with reference to two figures, in which:

FIG. 1 shows a graph depicting the relationship in principle between admission threshold, blocking probability and probability for a quality-of-service violation.

FIG. 2 shows an interface for an operator with inventive means for determining an optimum overbooking and for setting the overbooking factor.

### DETAILED DESCRIPTION OF INVENTION

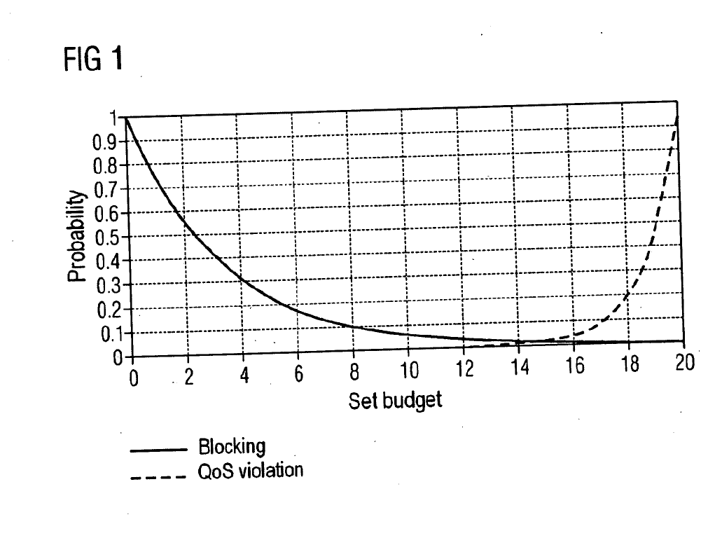

The unbroken line from FIG. 1 shows the blocking probability, while the dashed line plots the probability for a violation of the quality-of-service (QOS). Both variables are shown as a function of the admission threshold or, as the case may be, the limit for the admission control. If the admission threshold approaches zero, the probability for a blocking or, as the case may be, non-admission becomes very high, though on the other hand there is no risk of a quality-of-service violation. With a very high admission threshold, the probability for non-compliance with a quality-of-service feature increases sharply. On the other hand, practically all of the traffic can be serviced, so the blocking probability at the edge of the networks drops to zero. According to the invention the optimum between the two extremes is determined, which optimum in the given case corresponds to the determination of the minimum of the addition of the two curves. The admission threshold for an optimum utilization of the capacity of the network in respect of the two criteria, blocking and quality-of-service violation, should be set to this value.

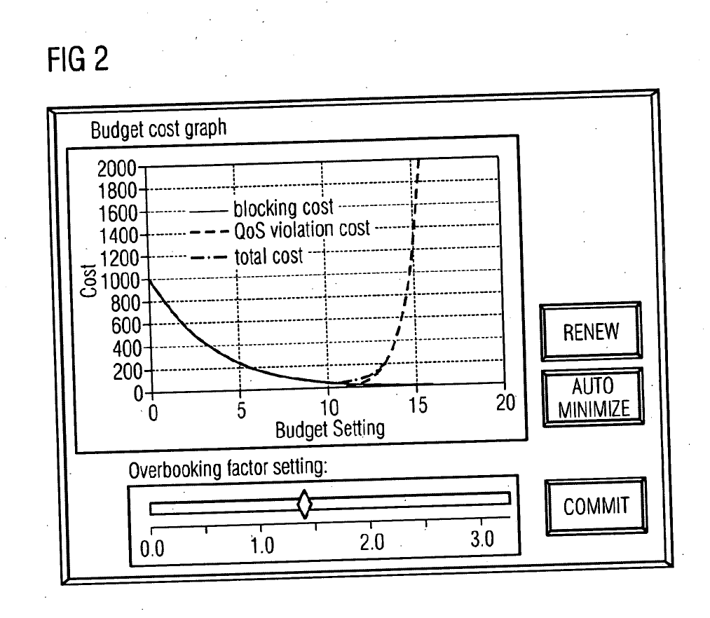

FIG. 2 shows an interface for setting the overbooking factor, with the curves in the graphical representation indicating costs rather than probabilities, i.e. the probabilities have been weighted e.g. according to economic criteria. The unbroken line shows the costs for blocking or, as the case may be, non-admission of traffic, while the dashed line shows the costs for violation of the quality of service. Also plotted is the addition of the two curves, the minimum of which indicates the optimum overbooking factor. Shown at the bottom of the figure is a bar by means of which the overbooking factor can be set manually. An operator can generate this interface on his/her control computer from his/her operator station and adjust the overbooking factor according to the displayed minimum for example by means of mouse clicks and by moving the marker along the bar.

1.-11. (canceled)

12. A method for determining an admission threshold which is optimized in respect of a transmission of traffic in a communication network with an access restriction, comprising:
determining and weighting a probability for a non-admission of traffic as a function of an admission threshold;
determining and weighting a probability for a non-compliance with a quality-of-service feature during the transmission of traffic as the function of the admission threshold; and
determining an optimum admission threshold in accordance with the weighted probabilities.

13. The method as claimed in claim 12,
wherein an overbooking of the communication network is made by an admission of a traffic volume which exceeds a limit used for the access restriction, and
wherein the optimum admission threshold is determined in the form of an optimum overbooking.

14. The method as claimed in claim 13, wherein the weighting is implemented in each case via a weighting value or a weighting function.

15. The method as claimed in claim 14, wherein a limit value for the non-compliance with the quality-of-service feature is specified via the weighting.

16. The method as claimed in claim 15, wherein a boundary condition for the non-compliance with the quality-of-service feature is specified via the weighting.

17. The method as claimed in claim 13,
wherein the optimum admission threshold is determined at regular intervals, and
wherein the access restriction of the communication network is set automatically in accordance with the determined admission threshold.

18. The method as claimed in claim 13, wherein a method for providing a redundant capacity is applied for the purpose of preempting malfunctions of the communication network.

19. The method as claimed in claim 13, further comprising a graphical representation of the weighted probability for the non-admission of traffic and of the probability for the violation of at least one quality-of-service feature.

20. The method as claimed in claim 13, further comprising an adjustable control for setting the overbooking.

21. A method for determining an admission threshold which is optimized in respect of a transmission of traffic in a communication network with an access restriction, comprising:
determining and weighting a probability for an average value for a proportion of non-admitted traffic as a function of an admission threshold,
determining and weighting an average value for a proportion of traffic for which a quality-of-service feature is not complied with as the function of the admission threshold; and
determining an optimum admission threshold in accordance with the weighted values.

22. The method as claimed in claim 21,
wherein an overbooking of the communication network is made by an admission of a traffic volume which exceeds a limit used for the access restriction, and
wherein the optimum admission threshold is determined in the form of an optimum overbooking.

23. The method as claimed in claim 22, wherein the weighting is implemented in each case via a weighting value or a weighting function.

24. The method as claimed in claim 23, wherein a limit value for the non-compliance with the quality-of-service feature is specified via the weighting.

25. The method as claimed in claim 24, wherein a boundary condition for the non-compliance with the quality-of-service feature is specified via the weighting.

26. The method as claimed in claim 25,
wherein the optimum admission threshold is determined at regular intervals, and
wherein the access restriction of the communication network is set automatically in accordance with the determined admission threshold.

27. The method as claimed in claim 26, wherein a method for providing a redundant capacity is applied for the purpose of preempting malfunctions of the communication network.

28. A device in a communication network, comprising:
a probability for non-admission of traffic determined and weighted as a function of the admission threshold;
a probability for non-compliance with at least one quality-of-service feature during the transmission of traffic determined and weighted as a function of the admission threshold; and
an optimum admission threshold determined in accordance with the weighted probabilities.

29. The device as claimed in claim 28, wherein the device is embodied as a server for controlling the access restriction of the communication network, a network management system or a service control system.

30. The device as claimed in claim 28, further comprising a graphical or textual representation of the weighted probability for the non-admission of traffic and of the probability for the violation of at least one quality-of-service feature.

31. The device as claimed in claim 30, further comprising an adjustable control for setting an overbooking for the admission threshold.
